(19) United States
(12) Patent Application Publication
(10) Pub. No.: US 2026/0108846 A1
(43) Pub. Date: Apr. 23, 2026

(54) METHOD AND SYSTEM FOR CARBON CAPTURE AND UTILIZATION

(71) Applicant: Chemical Trees LLC, Kingston, NH (US)

(72) Inventors: Michael F. Edwards, Kingston, NH (US); Nicholas M. Pitkin, Nottingham, NH (US)

(21) Appl. No.: 19/328,406

(22) Filed: Sep. 15, 2025

Related U.S. Application Data
(60) Provisional application No. 63/695,156, filed on Sep. 16, 2024.

(51) Int. Cl. B01D 53/62; B01D 53/14; B01D 53/26; B01D 53/78; B01D 53/82

(52) U.S. Cl. CPC B01D 53/62; B01D 53/1475; B01D 53/26; B01D 53/78; B01D 53/82; B01D 2251/604; B01D 2252/20421; B01D 2252/20426; B01D 2252/20431; B01D 2257/504; B01D 2257/80; B01D 2258/06

(57) ABSTRACT

Provided herein are methods and systems for capturing and utilizing CO₂. The methods and systems provided herein provide certain advantages over legacy technologies including low waste, low energy requirements, and few mechanized parts.

### CROSS-REFERENCE TO RELATED APPLICATIONS

This application claims the benefit of priority to U.S. Provisional Application No. 63/695,156, filed Sep. 16, 2024; the entire contents of which is incorporated herein by reference.

### BACKGROUND

Increased awareness of the impact of greenhouse gas emissions (primarily from combustion of fossil fuels) has prompted the development of methods to capture atmospheric CO₂ and convert it to non-gaseous compounds which can be used as feedstocks for other processes. However, many of these methods are inherently capital intensive, as they utilize significant amounts of energy, and can employ expensive materials and precious metals to perform the chemical transformations necessary. Accordingly, there is a need for improved methods for capturing and utilizing atmospheric CO₂.

### SUMMARY OF THE INVENTION

In certain aspects, provided herein are systems for capturing CO₂, the systems comprising:
an exchange chamber, comprising:
   a sorbent;
   a source fluid inlet;
   a product outlet;
   a first valve coupled to the source fluid inlet; and
an outlet manifold, comprising:
   a product inlet, wherein the product inlet on the outlet manifold is coupled to the product outlet on the exchange chamber;
an exhaust outlet; and
a second valve coupled to the exhaust outlet.

In certain embodiments, systems of the disclosure further comprise a water inlet; and the system comprises:
a third valve coupled to the water inlet and
a water source coupled to the third valve.

In further embodiments, the outlet manifold further comprises a CO₂-lean fluid outlet, the exchange chamber further comprises a CO₂-lean fluid inlet, and the system further comprises:
a fifth valve coupled to the CO₂-lean fluid outlet; and
a fourth valve coupled to the CO₂-lean fluid inlet;
wherein the fifth valve is coupled to the fourth valve.

In yet further embodiments, the system further comprises a CO₂-lean fluid chamber disposed between the fifth valve and the fourth valve.

In still further embodiments, the outlet manifold further comprises a CO₂ outlet, and wherein the system further comprises:
sixth valve coupled to the CO₂ outlet on the outlet manifold; and
optionally, a CO₂ chamber coupled to the sixth valve;
wherein the CO₂ chamber, when present, is coupled with the sixth valve.

In further embodiments, when the CO₂ chamber is present, systems of the disclosure further comprise a sequestration outlet, and the system further comprises:
a sequestration chamber comprising a catalyst and having a sequestration inlet;
wherein the sequestration outlet on the CO₂ chamber is coupled to the sequestration inlet on the sequestration chamber; or
when the CO₂ chamber is absent, the system further comprises:
a sequestration chamber having a sequestration inlet;
wherein the sixth valve is coupled to the sequestration inlet on the sequestration chamber.

In further aspects, the present disclosure provides methods of capturing CO₂ using a system of the disclosure, the method comprising the steps of:
opening the first valve, the second valve, and when present, the fifth valve;
closing the third valve, the fourth valve, and the sixth valve, when present;
flowing a source fluid through the first valve and into the exchange chamber;
capturing the CO₂ from the source fluid with the sorbent; and
flowing a CO₂-lean fluid through the fifth valve and into the CO₂-lean fluid chamber, when the CO₂-lean fluid chamber is present.

In certain embodiments, systems of the disclosure comprise the third valve, the fourth valve, and the fifth valve, and methods of the disclosure further comprise:
closing the first valve, the second valve, and the fifth valve;
opening the third valve; and
flowing water vapor through the third valve and into the exchange chamber;
thereby displacing the CO₂ from the sorbent to produce a CO₂-rich fluid,
optionally, wherein the method further comprises measuring a first CO₂ concentration in the source fluid and measuring a second CO₂ concentration in the CO₂ lean fluid, and, when the first CO₂ concentration and second CO₂ concentration are approximately equal, closing the first valve, the second valve, and the fifth valve.

In further embodiments, systems of the disclosure comprise the sixth valve, and methods of the disclosure further comprise:
closing the third valve;
opening the sixth valve; and
flowing the CO₂ rich fluid through the sixth valve and, when present, into the CO₂ chamber.

In yet further embodiments, systems of the disclosure comprise the fourth valve and the fifth valve, and methods of the disclosure further comprise:
closing the sixth valve;
opening the fourth valve and the second valve;
flowing the CO₂-lean fluid through the fourth valve and into the exchange chamber;
thereby displacing the water from the sorbent.

In yet further aspects, provided herein are methods of capturing CO₂, comprising the steps of: flowing a source fluid comprising CO₂ through an exchange chamber comprising a sorbent, thereby capturing the CO₂ from the source fluid and producing a CO₂-lean fluid.

In certain embodiments, methods of the disclosure further comprise storing the CO₂-lean fluid.

In further embodiments, methods of the disclosure further comprise increasing the relative humidity in the exchange chamber, thereby displacing the CO₂ from the sorbent to produce a CO₂-rich fluid.

In yet further embodiments, methods of the disclosure further comprise measuring a first CO₂ concentration in the source fluid and measuring a second CO₂ concentration in the CO₂ lean fluid, and, when the first CO₂ concentration and second CO₂ concentration are approximately equal, increasing the relative humidity in the exchange chamber, thereby displacing the CO₂ from the sorbent to produce a CO₂-rich fluid.

In still further embodiments, methods of the disclosure further comprise storing the CO₂-rich fluid.

In further embodiments, methods of the disclosure further comprise flowing the CO₂-lean fluid through the exchange chamber, thereby reducing the relative humidity in the exchange chamber, and displacing the water from the sorbent.

In yet further embodiments, methods of the disclosure further comprise contacting the CO₂-rich solution with a catalyst, thereby converting the CO₂ into carbon and O₂.

### BRIEF DESCRIPTION OF THE DRAWINGS

FIG. 1 is a schematic of an exemplary CO₂ capture system of the present disclosure.

FIG. 2 is a schematic of an exemplary CO₂ sequestration system that is suitable for use with the CO₂ capture systems described herein.

FIG. 3 is a photographic image of an exemplary CO₂ capture system of the present disclosure.

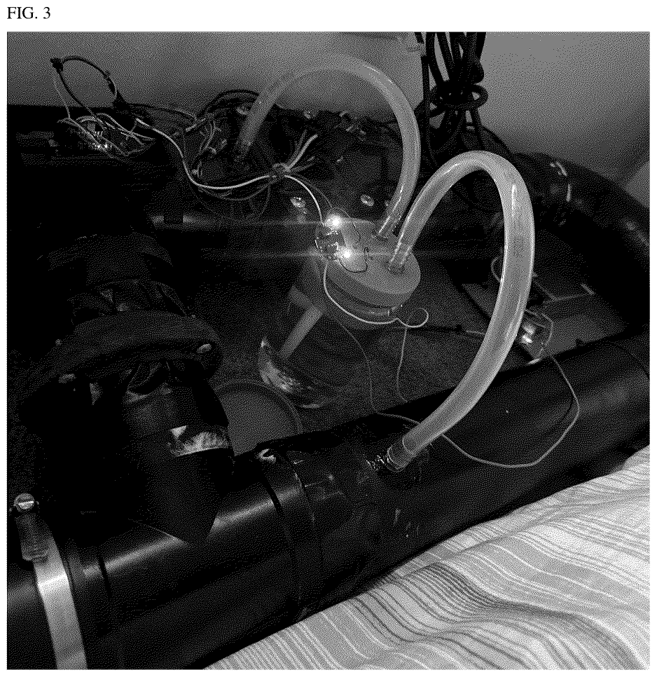

FIG. 4 is a photographic image of an exemplary sorbent suitable for use in the systems and methods described herein.

### DETAILED DESCRIPTION OF THE INVENTION

Provided herein are systems and methods for capturing CO₂. In certain aspects, the systems and methods provided herein afford numerous advantages over existing technologies, including that the steps may be easily repeated with low required energy input or waste and few mechanized parts. Further, the systems components and method steps may all be powered by energy from renewable sources. For example, solar energy may be used to run measuring devices, open and close valves, and operate pumps. Additionally, the systems described herein may be operated with relatively low energy input, affording cost advantages over more energy-intensive systems.

### Systems for Capturing CO₂

In certain aspects, provided herein are systems for capturing CO₂. In the present disclosure, certain components of these systems are described as being “coupled” to one another. As will be appreciated, the term “coupled” as used herein describes components that are operationally linked to one another, but does not preclude the presence of intervening components between those said to be coupled to one another. Additionally, as will be appreciated, various system components are described as “having”certain features.

Such descriptions do not preclude, and specifically contemplate, the presence of additional features, such as inlets, outlets, valves, control mechanisms, measurement devices, heating and/or cooling systems, etc. Additionally, in the systems of the present disclosure, certain components are described as having one or more outlets or inlets. Such outlets and inlets may represent separate structural elements, or may be combined into a single inlet or outlet as suitable. The person of ordinary skill in the art will recognize that, once the critical features and operating conditions of systems such as those described herein are understood, the detailed design and operation of such systems involved many choices, such as specific reagent flows, separation steps, etc. While the present disclosure provides a number of specific embodiments, any suitable combination of these design choices may be made.

In certain aspects, provided herein are systems for capturing CO₂, the systems comprising:
an exchange chamber, comprising:
   a sorbent;
   a source fluid inlet;
   a product outlet;
   a first valve coupled to the source fluid inlet; and
an outlet manifold, comprising:
   a product inlet, wherein the product inlet on the outlet manifold is coupled to the product outlet on the exchange chamber;
   an exhaust outlet; and
   a second valve coupled to the exhaust outlet.

As will be appreciated by one of ordinary skill in the art, any suitable sorbent, or combination thereof, may be used in the systems described herein. The various sorbents specifically described herein offer certain advantages in the systems of the present disclosure, but other sorbents known in the art may be used to good effect by one of ordinary skill in the art. For example, some suitable sorbents are disclosed in Shi, X., et al. “Kinetic Analysis of an Anion Exchange Absorbent for CO₂ Capture from Ambient Air.” PLOS One 2017, 12, e0179828, which is expressly incorporated by reference herein.

In certain embodiments, systems of the disclosure further comprise a water inlet; and the system comprises:
a third valve coupled to the water inlet and
a water source coupled to the third valve.

In further embodiments, the outlet manifold further comprises a CO₂-lean fluid outlet, the exchange chamber further comprises a CO₂-lean fluid inlet, and the system further comprises:
a fifth valve coupled to the CO₂-lean fluid outlet; and
a fourth valve coupled to the CO₂-lean fluid inlet;
wherein the fifth valve is coupled to the fourth valve.

In yet further embodiments, the system further comprises a CO₂-lean fluid chamber disposed between the fifth valve and the fourth valve.

In still further embodiments, the outlet manifold further comprises a CO₂ outlet, and wherein the system further comprises:
sixth valve coupled to the CO₂ outlet on the outlet manifold; and
optionally, a CO₂ chamber coupled to the sixth valve;
wherein the CO₂ chamber, when present, is coupled with the sixth valve.

In further embodiments, when the CO₂ chamber is present, systems of the disclosure further comprise a sequestration outlet, and the system further comprises:
a sequestration chamber comprising a catalyst and having a sequestration inlet;
wherein the sequestration outlet on the CO₂ chamber is coupled to the sequestration inlet on the sequestration chamber; or
when the CO₂ chamber is absent, the system further comprises:
a sequestration chamber having a sequestration inlet;
wherein the sixth valve is coupled to the sequestration inlet on the sequestration chamber.

In further aspects, the present disclosure provides methods of capturing CO₂ using a system of the disclosure, the method comprising the steps of:
opening the first valve, the second valve, and when present, the fifth valve;
closing the second valve, the third valve, the fourth valve, and the sixth valve, when present;
flowing a source fluid through the first valve and into the exchange chamber;
capturing the CO₂ from the source fluid with the sorbent; and
flowing a CO₂-lean fluid through the fifth valve and into the CO₂-lean fluid chamber, when the CO₂-lean fluid chamber is present.

In certain embodiments, systems of the disclosure comprise the third valve, the fourth valve, and the fifth valve, and methods of the disclosure further comprise:
closing the first valve, the second valve, and the fifth valve;
opening the third valve; and
flowing water vapor through the third valve and into the exchange chamber;
thereby displacing the CO₂ from the sorbent to produce a CO₂-rich fluid,
optionally, wherein the method further comprises measuring a first CO₂ concentration in the source fluid and measuring a second CO₂ concentration in the CO₂ lean fluid, and, when the first CO₂ concentration and second CO₂ concentration are approximately equal, closing the first valve, the second valve, and the fifth valve.

In further embodiments, systems of the disclosure comprise the sixth valve, and methods of the disclosure further comprise:
closing the third valve;
opening the sixth valve; and
flowing the CO₂ rich fluid through the sixth valve and, when present, into the CO₂ chamber.

In yet further embodiments, systems of the disclosure comprise the fourth valve and the fifth valve, and methods of the disclosure further comprise:
closing the sixth valve;
opening the fourth valve and the second valve;
flowing the CO₂-lean fluid through the fourth valve and into the exchange chamber;
thereby displacing the water from the sorbent.

### Methods for Capturing CO₂

In yet further aspects, provided herein are methods of capturing CO₂, comprising the steps of: flowing a source fluid comprising CO₂ through an exchange chamber comprising a sorbent, thereby capturing the CO₂ from the source fluid and producing a CO₂-lean fluid.

In certain embodiments, methods of the disclosure further comprise storing the CO₂-lean fluid.

In further embodiments, methods of the disclosure further comprise increasing the relative humidity in the exchange chamber, thereby displacing the CO₂ from the sorbent to produce a CO₂-rich fluid.

In yet further embodiments, methods of the disclosure further comprise measuring a first CO₂ concentration in the source fluid and measuring a second CO₂ concentration in the CO₂ lean fluid, and, when the first CO₂ concentration and second CO₂ concentration are approximately equal, increasing the relative humidity in the exchange chamber, thereby displacing the CO₂ from the sorbent to produce a CO₂-rich fluid.

In still further embodiments, methods of the disclosure further comprise storing the CO₂-rich fluid.

In further embodiments, methods of the disclosure further comprise flowing the CO₂-lean fluid through the exchange chamber, thereby reducing the relative humidity in the exchange chamber, and displacing the water from the sorbent.

In yet further embodiments, methods of the disclosure further comprise contacting the CO₂-rich solution with a catalyst, thereby converting the CO₂ into carbon and O₂.

The disclosure includes exemplary process conditions (e.g., temperatures, humidities, pressures, etc.) which provide certain advantages in context of the systems and methods disclosed herein. However, any suitable conditions may be used, and the person of ordinary skill in the art will appreciate how to vary the conditions of any particular process described herein to obtain results and tune product distribution as needed for particular applications, as contemplated.

As will be understood by those of skill in the art, the flow rate of source fluid, or various product mixtures through the various system components described herein (or elsewhere in the disclosed systems and methods) can be adjusted as needed to afford the desired product output characteristics.

The systems and methods of the present disclosure can be designed to utilize any combination of suitable source fluids. Said source fluids may, in certain embodiments, be provided into the requisite system components separately, or they may in certain embodiments be pre-mixed to provide a single feed stream comprising multiple source fluids.

In certain embodiments, the source fluid is CO₂. In further embodiments, the source fluid gas comprises CO₂. In further embodiments, the source fluid is, or is derived from, flare gas, waste gas, or natural gas. In preferred embodiments, the source fluid comprises CO₂ generated as a result of burning fossil fuels.

As will be understood by those of skill in the art, the flow rate of carbon source gas and/or reduction gas, or various product mixtures through the paraffin and/or aromatic reactors (or elsewhere in the disclosed systems and methods) can be adjusted as needed to afford the desired product output characteristics.

### Definitions

Unless otherwise defined herein, scientific and technical terms used in this application shall have the meanings that are commonly understood by those of ordinary skill in the art. Generally, nomenclature used in connection with, and techniques of, chemistry described herein, are those well-known and commonly used in the art.

The methods and techniques of the present disclosure are generally performed, unless otherwise indicated, according to conventional methods well known in the art and as described in various general and more specific references that are cited and discussed throughout this specification.

Chemistry terms used herein, unless otherwise defined herein, are used according to conventional usage in the art, as exemplified by “The McGraw-Hill Dictionary of Chemical Terms”, Parker S., Ed., McGraw-Hill, San Francisco, C.A. (1985).

All of the above, and any other publications, patents and published patent applications referred to in this application are specifically incorporated by reference herein. In case of conflict, the present specification, including its specific definitions, will control.

### EXAMPLES

The invention now being generally described, it will be more readily understood by reference to the following examples which are included merely for purposes of illustration of certain aspects and embodiments of the present invention, and are not intended to limit the invention.

### Example 1: Preparation of Exemplary Sorbents

An exemplary procedure is outlined below for preparing a suitable sorbent suitable for use in the presently disclosed systems and methods. Other suitable sorbents and methods of preparing the same are described in detail in Shi, X., et al. “Kinetic Analysis of an Anion Exchange Absorbent for CO₂ Capture from Ambient Air.” PLOS One 2017, 12, e0179828 the entire contents of which are herein incorporated by reference.
Step 1: Grind ion exchange resin (IER) using a blender. IER should be ground until it is a very fine powder. NOTE: the blender should be activated intermittently, as friction between the blades of the blender and the IER will cause the IER to heat up. Excessive heating of the IER should be avoided, as it denatures and becomes inoperable at 212° F.
Step 2: Mix PVC-THE solution. Add PVC and THF together with a weight ratio of 1:20, respectively (5 wt % PVC, 95 wt % THF). Mix until PVC is fully dissolved into THF. Add the same amount of IER as PVC to the PVC-THE solution. This should be mixed until the IER is dispersed evenly throughout the solution.
Step 3: Use a process to turn the solution into a thin membrane. Suitable methods include dip coating (dipping an object in the solution to create a thin film of IEM on the object). Suitable sorbent membranes were produced by pouring the solution onto a large sheet of aluminum foil. The solution spread itself out into a thin layer, which dried quickly. This process can be changed/added to optimize membrane thickness as needed. The final dimension of each sheet was about 8″×5″. Each sheet was used to create two sub-sized sheets that will go into the cartridge.
Step 4: Soak the membrane in distilled water. Water comprising fewer ions and other impurities is preferred to reduce risk of contaminating the resin.
Step 5: Wash the membrane with deionized (DI) water and treat them for several hours in ˜90° C. DI water. Then perform several cycles of soaking membranes in a sodium carbonate (Na₂CO₃) solution followed by rinsing in DI water. Sheets may then be cut to size, placed in the cartridge, and used for capturing CO₂.

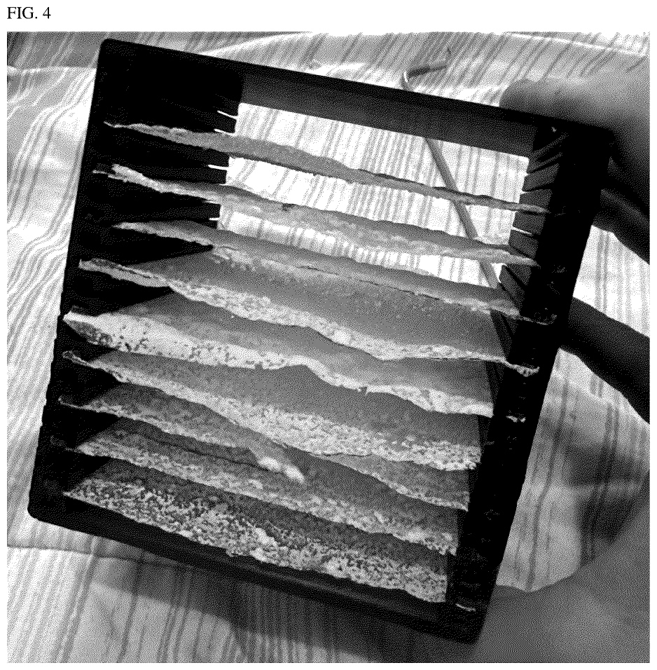

An exemplary stack of the sorbent membranes described above is depicted in FIG. 4.

### Example 2: Exemplary CO₂ Capture Procedure

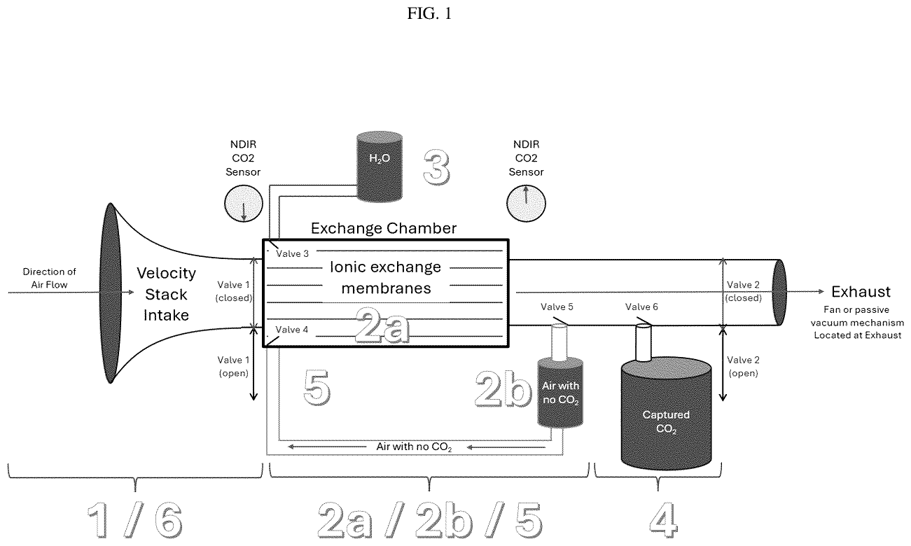

1. With reference to FIG. 1, Air is pulled into the device via the exhaust end, either by a passive vacuum or a solar powered induction fan. A velocity stack is used to improve flow and increase density. At this stage, valves 1, 2 and 5 are open and valves 3, 4 and 6 are closed. Most of the CO₂-free air is exhausted, while a small amount is captured in a storage tank via valve 5 for use in step 5.
2. a. An easy to make sorbent (e.g., a membrane according to Example 1) is stacked in a chamber and air passes through the sorbent, extracting CO₂ from the air. b. Some of the CO₂ free air is captured in a storage tank for drying the membrane in step 5.
3. When CO₂ sensor on exhaust side of chamber begins to read CO₂ (during the extraction process this sensor reads virtually no CO₂), valves 1, 2, and 5 are closed, thereby sealing off the chamber. Valve 3 is then opened and humidity in the chamber is increased to a specific level. This increase in humidity causes the membranes to release the CO₂molecules into the chamber. After a specific period of time, valve 3 is closed as CO₂ has been released from the membranes.
4. Valve 6 is then opened and the CO₂-rich air is pumped into a holding tank. Once a vacuum exists valve 6 is closed.
5. Now begins the process of drying the membrane. Via the prior steps, all valves are closed at the start of step 5. Valve 1 remains closed and valve 2 is opened at the same time valve 4 opens. The CO₂-free air in the holding tank is then allowed to flow over the membrane to dry the membrane to make it ready for another cycle of CO₂ extraction. When no humidity is detected in the chamber, valve 4 is closed.
6. Valve 2 remains open and valves 1 and 5 are reopened. The process may be repeated starting at step 1.

### Example 3: Exemplary CO₂ Sequestration Steps

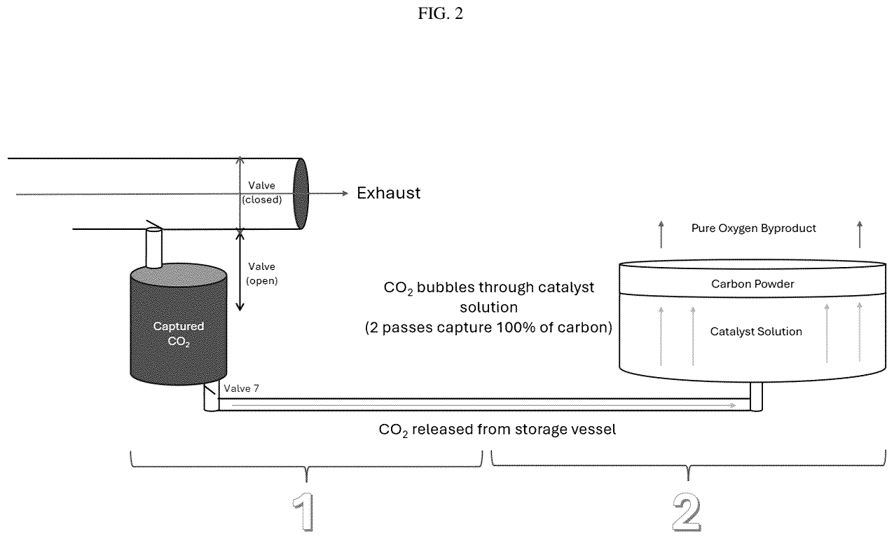

The following process may be used to sequester the CO₂ obtained via, e.g., the capture process described in Example 2 (using the CO₂-rich air from Step 4 of Example 2). Suitable variations of the sequestration steps described below may be found in, e.g., Nature Communications 2019, 10, 865; Energy & Environmental Science 2022, 15, 595-600; and EP4049328A1, the entire contents of each of which are herein incorporated by reference.
1. With reference to FIG. 2, During the process of extraction (e.g., as described in Example 2), a secondary process is ongoing. Once the CO₂ storage tank is full, Valve 7 is opened allowing the compressed CO₂ from the storage tank to be released to a pipeline.
2. The pipeline leads to the “bubbling” tank which is filled with a catalyst solution. As the CO₂-containing fluid bubbles through the solution, a carbon powder forms at the top of the solution while oxygen is released to the atmosphere as a by-product. The carbon powder is easily taken from the top of the solution for either final sequestration in the form of burying or to be used as a input to another industrial product. Valve 7 is closed once the CO₂ storage tank is emptied. Although not shown, the bubbling process may comprise two (or more) passes of the CO₂-containing gas to increase the amount of CO₂ is sequestered.

### INCORPORATION BY REFERENCE

All publications and patents mentioned herein are hereby incorporated by reference in their entirety as if each individual publication or patent was specifically and individually indicated to be incorporated by reference. In case of conflict, the present application, including any definitions herein, will control.

### EQUIVALENTS

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

1. A system for capturing CO₂, the system comprising:
an exchange chamber, comprising:
a sorbent;
a source fluid inlet;
a product outlet;
a first valve coupled to the source fluid inlet; and
an outlet manifold, comprising:
a product inlet, wherein the product inlet on the outlet manifold is coupled to the product outlet on the exchange chamber;
an exhaust outlet; and
a second valve coupled to the exhaust outlet.

2. The system of claim 1, wherein the exchange chamber further comprises a water inlet; and the system comprises:
a third valve coupled to the water inlet and
a water source coupled to the third valve.

3. The system of claim 1, wherein the outlet manifold further comprises a CO₂-lean fluid outlet, the exchange chamber further comprises a CO₂-lean fluid inlet, and the system further comprises:
a fifth valve coupled to the CO₂-lean fluid outlet; and
a fourth valve coupled to the CO₂-lean fluid inlet;
wherein the fifth valve is coupled to the fourth valve.

4. The system of claim 3, wherein the system further comprises a CO₂-lean fluid chamber disposed between the fifth valve and the fourth valve.

5. (canceled)

6. (canceled)

7. The system of claim 1, wherein the sorbent is configured to separate CO₂ from a source fluid, thereby producing a CO₂-lean fluid.

8-16. (canceled)

17. The system of claim 1, wherein the exchange chamber further comprises a velocity stack.

18. The system of claim 1, further comprising a device coupled to the second valve configured to reduce the pressure in the exchange chamber.

19. The system of claim 1, wherein the exchange chamber comprises the outlet manifold.

20. The system of claim 1, wherein the sorbent is disposed within the exchange chamber.

21. The system of claim 1, wherein the sorbent is a liquid.

22. The system of claim 20, wherein the sorbent comprises a primary, secondary, or tertiary amine, or a hydroxide.

23. The system of claim 1, wherein the sorbent is a solid.

24-29. (canceled)

30. The system of claim 1, wherein the outlet manifold further comprises a CO₂ outlet, and wherein the system further comprises:
sixth valve coupled to the CO₂ outlet on the outlet manifold; and
optionally, a CO₂ chamber coupled to the sixth valve;
wherein the CO₂ chamber, when present, is coupled with the sixth valve.

31. The system of claim 30, further comprising a desiccant chamber coupled to the sixth valve, and the desiccant chamber comprises a desiccant.

32. The system of claim 30, wherein the system comprises the CO₂ chamber coupled to the sixth valve, and the CO₂ chamber comprises a desiccant.

33. (canceled)

34. The system of claim 30, wherein:
when the CO₂ chamber is present, the system further comprises a sequestration outlet, and the system further comprises:
a sequestration chamber comprising a catalyst and having a sequestration inlet;
wherein the sequestration outlet on the CO₂ chamber is coupled to the sequestration inlet on the sequestration chamber; or
when the CO₂ chamber is absent, the system further comprises:
a sequestration chamber having a sequestration inlet;
wherein the sixth valve is coupled to the sequestration inlet on the sequestration chamber.

35. The system of claim 34, wherein the catalyst is configured to convert CO₂ to carbon and O₂.

36. The system of claim 34, wherein the catalyst comprises one or more elements selected from Ce, Ga, In, and a combination thereof.

37. (canceled)

38. (canceled)

39. A method of capturing CO₂ using the system of claim 3, the method comprising the steps of:
opening the first valve, the second valve, and the fifth valve;
closing the third valve and the fourth valve;
flowing a source fluid through the first valve and into the exchange chamber;
capturing the CO₂ from the source fluid with the sorbent; and
flowing a CO₂-lean fluid through the fifth valve.

40-42. (canceled)

43. A method of capturing CO₂, comprising the steps of:
flowing a source fluid comprising CO₂ through an exchange chamber comprising a sorbent, thereby capturing the CO₂ from the source fluid and producing a CO₂-lean fluid.

44-83. (canceled)
